(19) United States
(12) Patent Application Publication
(10) Pub. No.: US 2025/0135389 A1
(43) Pub. Date: May 1, 2025

(54) SELF CLEANING SCRUBBER FOR SILICON WAFER CUTTING PROCESSES

(71) Applicant: Garry Parkinson Isaacs, Pocatello, ID (US)

(72) Inventor: Garry Parkinson Isaacs, Pocatello, ID (US)

(21) Appl. No.: 18/202,447

(22) Filed: Sep. 25, 2024

Related U.S. Application Data
(63) Continuation of application No. 63/473,982, filed on Jul. 13, 2022.

(51) Int. Cl. B01D 50/40; B01D 45/14; B01D 47/00

(52) U.S. Cl. CPC B01D 50/40; B01D 45/14; B01D 47/00; B01D 2221/14

(57) ABSTRACT

The improvement of prior art air cleaning devices and processes is provided by the present disclosures in the form of a single, compact point of use scrubber to be used for extracting particles and harmful gases from a discharged air streams from processes required in electronic chip manufacturing. The device and processes described in the present invention are a compact series of apparatus improved for more effective capture of particulates, harmful gases and excess humidity required to be eliminated prior to emission into ambient air. The device uses less water, reduced sized water droplets and natural polarity of particles and droplets as a self cleaning capture mechanism for cleaner and less humid discharge into ambient air without the use of filters, ESP or WESP devices. Periodical shutdown of production lines and maintenance costs are significantly reduced or eliminated as the device cleans itself by continuous operation. Improvements in impaction and multiplicity of low pressure zones are provided by the device of various but not limited to the provided selection options of impeller liners used in the process disclosures.

### FIELD OF THE INVENTION

The field for which the invention applies is specific to air cleaning and the removal of harmful chemicals and particles, including particles smaller than 2.5 microns from gas streams. Gravitational and droplet impaction effects specific to wet contact and capture of soluble toxic gases and particles smaller than 2.5 microns produced by the action of micro-chip production are applied for Increased performance and an improvement to the devices and processes described in previous patents, methods and devices.

The embodiment of the invention is specific to increased reduction of particle sizes and population in a particle laden air stream using more abrupt low pressure zones around the periphery of an impeller. Improvements to the previously patented processes are disclosed for more effective capture of particles and gases in a waste gas stream by improved flow control and more effective impaction, increased graduations of velocity and reduced pressure implemented by various configuration liners in a rotational scrubber device. The particles contained in the gas are mixed with or adhered to liquid droplets to let the self cleaning apparatus wet removal of particles and gases take place.

### BACKGROUND OF THE INVENTION

Various purifiers have been previously created to remove particles contained in a gas stream. For example, a filter method, a wet method, an electrostatic accumulation method, a parallel multiple venturi method, a serial venturi method and the like have been employed.

Previous multi-venturi inventions have been made and employed in view of the problems of removing particles from a gas stream. The present invention is an improvement of previous devices that pressurizes a mixture of cleaning liquid droplets and particle-containing gas with an impeller and a plurality of colliding anvils formed inside the impeller housing to splatter the cleaning liquid into smaller droplets. The process as described in the embodiment of the present invention is a hydraulic form of electrostatic precipitation (ESP) increased population and size reduction of liquid droplets as a substrate for the collection of particulates from an air stream as applied to particle/droplet relationships as an improvement to customary droplet surfaces, plates or filter adherence methods.

The following facts are essential as specifically applied in the present apparatus for a full understanding of the background of the invention.

1. Water is a polar molecule. H atoms are positive and the O atom is negative. The surfaces of water droplets are negative oxygen because the two positive hydrogen atoms, being placed 104.5 degrees apart from each other by polar repulsion, have attached themselves to separate negative oxygen atoms and are turned inward from the surface of water droplets thereby creating surface tension at the surface. Most particulates are positive carbon so they can be readily attached to the negative oxygen surfaces of water droplets and carried away with the water. The challenge is to make the water droplets as small as the particles in the gas stream; small enough and numerous enough, the particle population sparse enough and the pressure low enough for the particulates to all collide with the sub-micron water droplets and become wetted and attached to them.

2. Atmospheric pressure at sea level on the earth is about 29.92 inches of mercury which is equal to 14.69 psi. What is meant by “normal” air pressure is the atmospheric pressure of the air at a given altitude or elevation from sea level.

3. The atmospheric pressure in a standard wet scrubber is about the same as the atmospheric pressure of the environment around it. The atmospheric pressure prevents the lighter particles and droplets from coming together. In fact they will dodge one another because the pressure of the air around them creates a cushion between them. High pressure nozzles used in standard wet scrubbing techniques create droplets no smaller than approximately 10 microns in diameter, most are larger than that. (A human hair is about 20 microns in thickness)

4. In order for two objects, whether large or small, whether solid, liquid or gas to collide, the air between them must get out of the way or the air would be compressed so much that the increasing pressure between the objects would prevent the objects from colliding. Larger particles will develop more momentum than sub-micron particles because of their higher weight, so in order to make sub-micron particles, either solid or liquid collide with one another, the pressure between them must be severely reduced or removed.

5. Rain is not the primary mechanism for nature to clean the atmosphere as is commonly believed and applied by early wet scrubbing techniques. The atmosphere of the earth is cleaned at higher altitudes where the pressure is at zero psi and the ice crystals can attach themselves to the tiny particles by the negative polarity of the water molecules. What the rain or snow does is deliver the adsorbed particles and absorbed soluble gases back to the surface of the earth by gravity.

6. As velocity increases, pressure decreases proportionally and equally. Imagine how an airplane wing works to create lift: the distance from the leading edge of the wing over the top of the wing to the trailing edge is greater than the distance from the leading edge to the trailing edge on the underside of the wing. This causes the air to move more rapidly over the top of the wing than it does under the bottom. The increased velocity causes lower pressure and therefore less resistance on top of the wing than there is under the wing. The pressure differential between the top of the wing and the bottom of the wing causes the wing to follow the upward path of least resistance, thereby creating the lift necessary for the plane to fly. The same principle of reducing pressure by increasing velocity can be applied by multiple, serial devices for less pressure restriction of the colliding of particles with droplets.

7. Each of the venturi zones in the previously patented devices causes a necessary increase of the air velocity in order for the air to pass through the narrow zones. The increased velocity in the narrow zones lowers the pressure proportional to the increase in velocity. As the velocity increases the pressure is lowered, the pressure cushion that prevents a collision of the water droplets with either the gas or solid particulates is decreased with a decrease in pressure or completely removed at zero psi. The present invention is an improvement in the application and implementation of the previously patented devices and processes.

8. The multiple venturi zones as described in the previous inventions work in a series, one after another, not parallel simultaneously. The first narrow zone has been measured in tests to be zero psi. Each of the following stages or zones also lower the pressure by increased velocity. The pressure in each zone gradually increases as the flow of the air stream gets closer to the high pressure discharge point. The multiple low pressure zones, as described in the previous cited patents are improved by the present invention by an increased number of low pressure zones in conjunction with additional impaction anvils to a point of a high number of liquid droplets and increased collisions of water droplets with the solid or gas particles.

9. The population of the droplets in the low pressure zones is important because the higher the population of droplets, the more opportunities are created for particles and gases to collide with the water and be adsorbed if insoluble or absorbed if soluble. That is why impaction at low pressure is important for the performance of the previously patented inventions. Example: Dividing a 20 micron droplet into droplets half the diameter creates 8-10 micron droplets. to divide the droplets in half again exponentially creates 64 droplets and so on.

10. It is also important to note that particles and gases must meet the surface of a water droplet in order to react with it. By dividing a droplet into droplets half their diameter additional surfaces are exponentially created as well. Dividing a 20 micron droplet into 10 micron droplets increases the number of droplets by 8 times but it also increases the surface area available for adsorption of particles or absorption of soluble chemicals by 4 times and population and surface areas of droplets are exponentially increased as the droplets are made smaller.

### OBJECT OF THE INVENTION

An object of the present invention is to provide an improved and more compact impeller-type air purifier configured to improve the wetting and removing effect of particles by generating the multiple venturi effect by the inclined surface structure of the anvil part as described in previous inventions with the additional improvements in air flow, condensation and gravitational factors that apply specifically to scrubbing sub-micron dust particles and gases generated by microchip manufacturing and cutting processes and others.

The capture of sub-micron particles with previous patented products has been hindered by over crowding of particles thereby causing the prevention of every particle coming in contact with a liquid droplet. The forgoing description of the process of scrubbing produced by the previously patented devices is further enhanced by the present invention by the pressure and gravitational forces produced by induced draft, gravity and momentum adjustments to the flow pattern, pressure differentials, and directional changes effecting the flow patterns and condensation surface contacting.

### SUMMARY OF THE INVENTION

Gravitational and droplet impaction effects specific to wet contact and capture of soluble toxic gases and particles smaller than 2.5 microns produced by the action of micro-chip production are applied for Increased performance and an improvement to the devices and processes described in previous patents, methods and devices.

The embodiment of the invention is specific to increased reduction of particle sizes and population in a particle laden air stream using more abrupt low pressure zones around the periphery of an impeller. Improvements to the previously patented processes are disclosed for more effective capture of particles and gases in a waste gas stream by improved flow control and more effective impaction, increased graduations of velocity and reduced pressure implemented by various configuration liners in a rotational scrubber device. The particles contained in the gas are mixed with or adhered to liquid droplets to let the self cleaning apparatus wet removal of particles and gases take place.

### References Cited

KR 10-0710689 Isaacs

U.S. Pat. No. 6,905,537 Isaacs Jun. 14, 2005

U.S. Pat. No. 11,143,195 B2, Isaacs et al May 2019

KR 10-2080220 Isaacs Feb. 17, 2020

U.S. Pat. No. 11,590,445 KIM et al Feb. 28, 2023

U.S. Pat. No. 11,077,401 Catalano Aug. 3, 2021

US Pub No.: 2010/0126349 Vermeulen May 27, 2010

U.S. 2017021367A1 2017-1-26

### BRIEF DESCRIPTION OF THE DRAWINGS

The drawings provide an illustrated view of the embodiments, function, operation and flow patterns of the device. The functions of each of the stages are illustrated by following the flows from entry to discharge of both air and scrubbing fluid as applied in each of the use and processes of the incorporated devices. The embodiments of the device may be employed in different ways by those skilled in the art and are not limited to the descriptions and uses in this disclosure and by these illustrations.

### DETAILED DESCRIPTION OF THE DRAWINGS

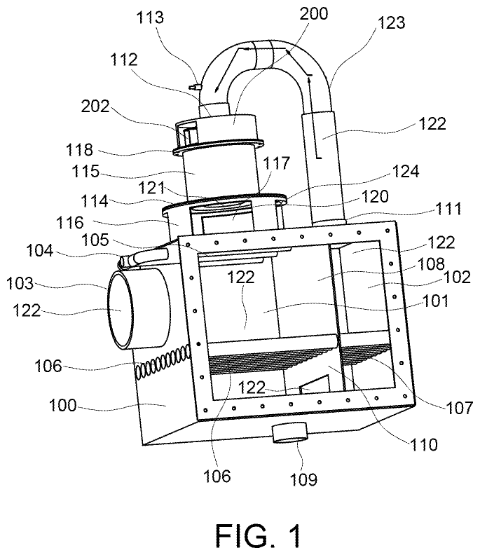

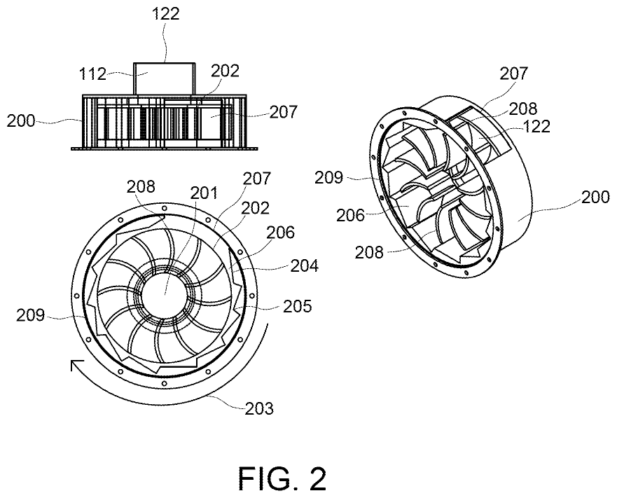

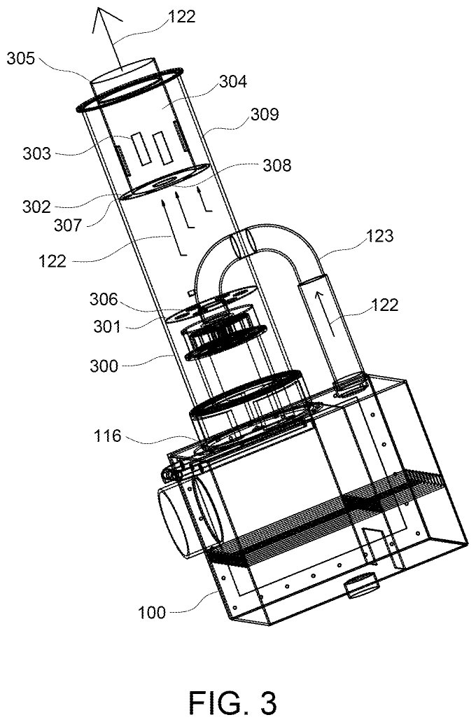

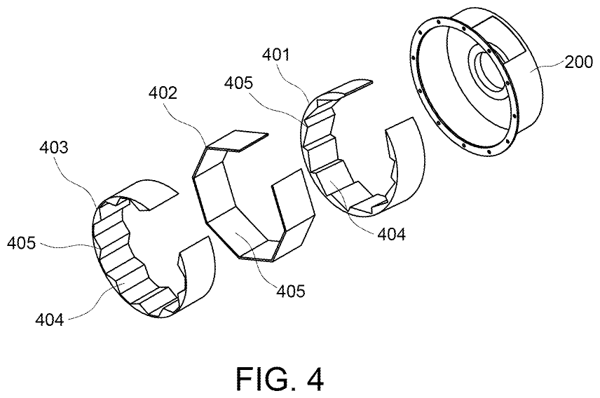

FIG. 1 is a schematic sectional view of the process of an air purifier according to an embodiment of the present invention; FIG. 2 is a schematic view of an air purifier impeller with an optional inserted liner according to an embodiment of the present invention; FIG. 3 is a schematic sectional view of the mist elimination device according to the finishing stage of the present invention. FIG. 4 is a schematic sectional view of insertable liner options as an apparatus of the present invention.

Hereinafter, preferred embodiments of the present invention will be described in detail with reference to the accompanying drawings.

FIG. 1

A box 100 is provided with a primary compartment 101 for first stage rod deck 106 removal of the larger particles and a second compartment 102 for rod deck 106 separation of smaller particles by upward vacuum and flow 122 of the air through the box 100 from the first inlet 103 through the entire box 100 until it exits upward through a vacuum suction vent 111.

A DC electric motor 121 that drives the impeller 202 is mounted on a motor mount plate 118 inside a motor housing 115 supported by a pedestal 116 with air circulation openings 117 to provide cooling and access to the motor 121. The pedestal 116 is attached at the top to a plate 114 with an open bottom to provide and at the bottom of the mist eliminator 300 and to the bottom of the motor housing 115.

The particle and chemical laden air is moved by the motive force of the impeller 202, creating a vacuum, induced by the rotation 203 of the impeller 202. The air stream 122 enters the rod deck scrubber compartment 100 from the source of particle and chemical laden air produced by the micro-chip material sawing process through the inlet 103. A liquid spray manifold 105 is fed with water at the water source inlet connection 104 and distributed by pressure into the multi section spray manifold 106 and delivered through multiple spray nozzles evenly spaced on the bottom sides of the manifold tubes 105. The spray nozzles spread water droplets evenly distributed through the airspace above the particle and chemical laden air that has entered the first compartment 101 of the box 100. Rods are sized and spaced apart from one another to create combined air passage spaces 107 equal in area to approximately the same as the area of the inlet 103 to establish downward velocity and pressure for particle contact with the surfaces of the water droplets through the spaces between the rods.

Wetted particles drop by gravity to the floor of the rod deck scrubber compartment 101 and are drained away through the drain 109 at the bottom of the box 100. An open gateway 110 is provided between compartment 101 and a second stage compartment 102 for entry of the air by vacuum induction created by the impeller 202.

The reduced population and reduced sized solid particles that are remaining in the air stream and that are not wetted and gravitationally drained away in the first stage 101 of the rod deck scrubber 100 are vacuumed upward 122 through the rods provided by the second stage rod deck 107 in the second compartment 102. The remaining particles and gases are vacuumed in an upward direction 122 through a suction tube 123 and are introduced to the multiple series venturi finishing scrubber impeller housing 200 of the device at the intake 112 of the impeller housing 200.

FIG. 2

The particles and soluble gases that remain in the air stream 122 that is vacuumed from the rod deck scrubber 100 are introduced through the inlet 112 of the impeller housing 200 into the center 201 of the impeller 202. A nozzle 113 is attached to the suction tube 123 within 2 inches from the inlet 112 of the impeller housing 119 where additional liquid is introduced to the air stream 122. The air stream 122 and the additional liquid that is introduced through the nozzle 113 are driven simultaneously by centrifugal force against the anvils 204 of the liner 209. The additional liquid is splattered multiple times on a series of anvils 202 and broken into an exponentially increased population of microscopic droplets. Particles remaining in the air stream 122 after being vacuumed upward from the rod deck scrubber 100 are wetted and entrained by the clockwise rotation 203 of the water fed impeller 202 driving liquid droplets and particles together through a series of low pressure zones 205 that increase the velocity and simultaneously reduce the pressure in the stream 122. Each time the pressure is reduced or eliminated through the narrowed spaces at the peaks of the narrow low pressure zones 205 remaining particles are contacted with liquid droplets and are wetted and captured into the liquid.

Back pressure at the outlet 207 of the impeller housing 200 causes the entire stream 122 that is discharged by the impeller 202 in a centrifugal motion to follow the path of least resistance which is the first low pressure zone 205. The liquid stream 122 containing the particles and soluble gases is impacted multiple times by repeatedly driving the stream through a series of impact anvils 206 and low pressure zones 205 for additional contacting and wetting and then discharged by the velocity of the impeller 202 through the outlet 207. The liquid stream 122 is driven tangentially by momentum against the round interior wall of the mist eliminator compartment 300 by the positive force discharged from the tips of the impeller vanes 208.

The tangentially forced discharge 207 of the stream 122 starts the fluid containing the particles and soluble gases to move around the interior wall of the mist eliminator 300 in a circular swirling liquid stream. Particles and soluble gases are encapsulated and absorbed by the liquid droplets and are driven by momentum into the liquid stream and dropped out with the liquid by gravity. The liquid stream is drained gravitationally out of the system through the drain 124 into the top of the first compartment 101 of the rod deck scrubber box 100 and further eliminated through the drain 109 at the bottom of the rod deck scrubber box 100.

The remaining cleaned air stream 122 containing the smaller droplets and humidity that are not gravitationally dropped out with the main liquid stream is forced upward in the mist eliminator 300 by the forced draft created by the impeller 202.

FIG. 3

After departing the impeller housing 200 through the discharge opening 207 the air is forced upward into the mist eliminator 300 through six evenly spaced holes 306 in the lower baffle 301 with a combined hole 306 area equal to approximately one half of the area of the vent 305 at the top of the mist eliminator 300 and approximately three times the area of the inlet 112 of the impeller housing 200 thereby reducing the velocity of the air stream 122 through the mist eliminator 300 to approximately one third of the velocity of air discharged from the impeller. The air stream 122 is forced further upward through a second upper baffle 302 and is forced through a series of evenly spaced holes in the baffle 302 and a center hole 308 with a combined hole 307 and hole 308 areas, including the space 309 between the outer edge of the baffle 302 and the interior wall of the mist eliminator 300 that provides a total space proportional to approximately two thirds of the area of the discharge vent 305. A vertical discharge tube 304 with evenly spaced rectangular slots 303 with a total combined area of approximately one half of the area of the discharge port 305.

FIG. 4

A round impeller housing 200 is shown that is a receptacle for the insertion of optional liners that are selected for desired effects of particle content, size and chemical solubility of the content of the gas stream being scrubbed. The liner option 401 is configured to provide multiple graduated low pressure zones 404 in series for improved particle and droplet collisions through the narrow low pressure zones 405. The liner option 402 consists of a seven low pressure zones 405 configuration that is used in previous patents cited in this application. Liner option 403 consists of an improved configuration with an increased number of impaction anvils 404 along with an increased number of more abrupt low pressure ridges 405 for repeated reduction of liquid droplet sizes by impaction 404 and shorter acceleration zones 405 to provide improved performance as required by a particular content and solubility of specified impurities in a gas stream.

1: A self cleaning water fed apparatus for cleaning waste gas of the electronics industry comprising of the following elements incorporated into a single, compact, self contained and complete finishing device and process of preventing the emission of harmful particles and gases.
A. A water fed parallel rod deck scrubber to remove particles larger than 2.5 microns in diameter by rod deck in series. The rod deck scrubber consists of multiple narrow zones provided in parallel for the passing of particle laden air through a layer of rods in parallel with one another. The apparatus provides a two chambered rod deck with an upward induction second stage for gravitationally aiding separation of particles from an induced draft gas stream. The force required for transfer and for additional energy to overcome the resistance of the convoluted flow patterns and particle weights is provided by induced upward draft provided by an energy source and an encapsulated water fed impeller of the device.
B. Using gravity to enhance the reduction of particle population in an upward drafted flow pattern through the second stage rod deck further reduces the population and size of particles entering the impeller driven stage of the device. Combining induced draft to the two stage rod deck preliminary scrubbing process with the water fed impeller driven scrubbing action of the cited previous Isaacs patents overcomes the problem of over crowding of particles in the airstream and provides a more concentrated interior mist elimination method in a single pass system.
C. Particle/droplet collisions are assured by the reduced population and sizes of the particles entering the water fed impeller driven scrubber phase and droplets containing the sub-micron particles discharged from the impeller driven scrubber are captured by multi-directional surface adherences for collision and condensation in the mist eliminator stage of the device.
D. A rounded impeller housing to provide the insertion of optional liners of different configurations to accommodate certain enhancements as required for more effective mixing of particles and gases from particular substances contained in the source and body of a flowing gas stream with water droplets.
E. A self contained rotational impeller driven cleaning device mounted in the interior of a mist eliminator that does not accumulate particles in a filter or on ionically charged plates and surfaces that need periodical cleaning or replacement.
F. A comprehensive and compact self contained apparatus that uses less water by optimal adjustment of droplet to particle population ratios and that is cleaned by its operation and by periodical flushing if needed by increasing water flow for a few seconds at a time.

2: An apparatus of claim 1 consisting of a water fed induced draft device mounted inside of a mist elimination chamber that provides a process of passing particles and gases through a multi staged rod deck parallel venturi scrubber in a primary downward and a secondary upward induced draft flow pattern.

3: An apparatus of claim 1 consisting of a water fed impeller device mounted inside a mist elimination chamber and a process of gravitationally separating small particles from large particles in an air stream by adjusting the volume of scrubber water and controlling the induction rate and draft pressure of the incoming and outgoing flow streams.

4: An apparatus of claim 1 consisting of a round impeller housing to allow for the insertion of various configuration liners providing a choice of configuration for effecting the wet capture of particles and gases requisite to material, particle size, population and solubility of chemicals and gases in the source gas stream.

5: An apparatus of claim 1 consisting of an impeller housing liner with multiple anvils and multiple gradual inclining zones for repeated accelerations of the flow rate with corresponding pressure decreases for serial venturi wetting, adsorption of solid particles and and absorption of chemicals and soluble gases with water droplets moving simultaneously in an air stream.

6: An apparatus of claim 1 consisting of an impeller housing liner with a choice of multiple steeper angled anvils to increase the force of repeated impact of droplets to reduce the sizes of and increase the population of droplets in the air stream for more effective particle collection by mixing with water in serial ridged low pressure points.

7: An apparatus of claim 1 consisting of an impeller housing liner with reduced angles of impaction of droplets and gradually increasing serial low pressure zones for improved and increased number of multiple low pressure zone contacting of particles and gases with liquid droplets.

8: An apparatus of claim 1 that is a mist eliminator with two or more perforated disc plates with round holes evenly placed and a finishing vertical discharge tube with evenly placed rectangular, perforated slots for disrupting an even flow pattern and causing an improvement in droplet/surface adherence and condensation that prevents the emission of sub-micron particles, droplets and humidity.
